(19) United States
(12) Patent Application Publication
(10) Pub. No.: US 2010/0019135 A1
(43) Pub. Date: Jan. 28, 2010

(54) ROTARY ENCODER FOR CONNECTING ADDITIONAL SENSORS AND ELECTRICAL MACHINE COMPRISING A ROTARY ENCODER OF THIS TYPE

(75) Inventors: Rainer Eckert, Bad Neustadt (DE); Karl-Heinz Filbry, Hochheim (DE); Ulrich Höhn, Hollstadt/Junkershausen (DE); Hans-Werner Lipot, Bad Neustadt (DE); Markus Platen, Bad Neustadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/439,313

(22) PCT Filed: Aug. 16, 2007
(86) PCT No.: PCT/EP07/58513

§ 371 Date: Feb. 27, 2009

(30) Foreign Application Priority Data
Sep. 1, 2006 (DE) 10 2006 041 056.4

(51) Int. Cl. G01D 5/34

(52) U.S. Cl. 250/231.13

(57) ABSTRACT

The invention relates to a rotary encoder (1) with a sensor (2) for detecting a measured variable that is dependent on the rotational position of a rotatable object, the rotary encoder (1) having at least one rotary encoder output (8) for emitting a rotational signal (DS) that corresponds to the measured variable. The rotary encoder (1) has a terminal (9) for connecting at least one other sensor (10). The rotary encoder (1) has at least one sensor signal output (11) for emitting an additional signal (WS), which corresponds to a measured variable detected by the other sensor(s) (10).

The invention relates to a rotary encoder having a sensor for detecting a measurement variable which is dependent on the rotational position of a rotatable object. The rotary encoder has at least one rotary encoder signal output for outputting a rotation signal which corresponds to the measurement variable.

The invention also relates to an electrical machine comprising a rotary encoder of this type.

Rotary encoders are used to measure distances, velocities or rotational angles of a rotatable object which is connected to the rotary encoder. For this purpose, the rotary encoders have a sensor for detecting a rotational position or change in rotational position. Such rotary encoders are able to detect a rotational angle with a very high rotational angle resolution, for example with a resolution of 0.1°.

In the industrial environment, rotary encoders are used, for example, in machine tools, in robotics and automation technology and in measuring and test devices.

The rotary encoder may be, for example, an encoder which detects the absolute rotational angle position and outputs a corresponding coded signal. The rotary encoder may also be an incremental rotary encoder which outputs, for example, two signals which are offset by 90° with respect to one another. Relative changes in the rotational angle can be determined from the two rotary encoder signals.

Incremental rotary encoders which additionally output a reference signal given a predetermined rotational angle are also known. The absolute rotational angle can be derived by evaluating this signal.

Rotary encoders may be based, for example, on a photoelectric or magnetic principle. In the former case, a light beam which is generally produced by an LED is passed, through a scanning plate which is provided with lines or slots, to a photooptical sensor, generally a phototransistor. If the scanning plate rotates, the light beam is cyclically modulated between the LED and the phototransistor. A corresponding rotary encoder signal can be generated from the modulated signal from the phototransistor.

Such rotary encoders can be fitted, for example, to an end of the rotor shaft of an electrical machine for the purpose of detecting the change in rotational position of the rotor shaft. The rotary encoder may alternatively be connected to the rotor shaft by means of a toothed belt. The rotary encoder signals are usually needed to monitor and/or control the electrical machine. The electrical machine may be an electric motor or a generator, for example. It may be an asynchronous or synchronous machine.

Electrical machines usually have additional sensors for monitoring the electrical machine. The sensors may be temperature sensors, vibration sensors, winding fracture sensors, a rotary encoder as described above or the like. The sensors are preferably fitted at locations in the electrical machine which need to be monitored, for example in the winding overhang or in the region of the motor bearings.

The associated sensor signal lines, which carry signals, and, if appropriate, the voltage supply lines of the sensors may be connected to a terminal strip. The terminal strip is preferably accommodated in a terminal box for externally connecting the sensors.

Alternatively, sensor electronics which use a multiplicity of sensors fitted in the electrical machine to detect corresponding sensor signals may be accommodated in the electrical machine. Following metrological processing, the sensor signals detected may be output as measured values via a bus interface, for example via an RS232 interface.

One object of the invention is to specify an improved rotary encoder.

Another object of the invention is to provide a suitable electrical machine having such a rotary encoder.

The object is achieved with a rotary encoder having the features of patent claim 1. Advantageous refinements are mentioned in dependent claims 2 to 19. Claim 20 specifies a suitable electrical machine having a rotary encoder according to the invention. Dependent claim 21 mentions one advantageous refinement of the electrical machine.

According to the invention, the rotary encoder has a connection for connecting at least one additional sensor. The rotary encoder also has at least one sensor signal output for outputting an additional signal which corresponds to a measurement variable detected by the at least additional sensor.

This advantageously reduces the assembly complexity for connecting the additional sensors.

The connection may be, for example, a terminal strip or socket connector which is fitted in or on the rotary encoder. The respective ends of the lines of the additional sensor may be pushed or inserted into the terminal strip or socket connector and then fixed.

The additional signal and, if appropriate, the signal from the respective connected sensor, which signal has been conditioned using signal technology, can be tapped off at the respective sensor signal output of the rotary encoder or can be forwarded using a signal line. Conditioning using signal technology may comprise, for example, amplification or discrimination of the respective sensor signal.

In one embodiment, the connection for the at least one additional sensor is in the form of at least one bus interface.

The particular advantage of this embodiment is that sensors with a standardized connector can be easily inserted into a corresponding bus connection socket of the rotary encoder. The assembly complexity is reduced again.

Another advantage is that the measurement variable detected by a sensor is usually in the form of a digitized measured value which is transmitted to the bus interface of the rotary encoder. The bus interface may be, for example, a standardized USB interface. A USB connector and a corresponding socket advantageously have compact dimensions.

Another advantage of the USB interface is that an inserted sensor and the sensor's USB circuit parts can be supplied with power.

Alternatively, it is possible to use a so-called Firewire interface based on an IEEE 1394 standard, a CAN bus or an I²C bus interface.

According to another embodiment, the rotary encoder has a first measurement detection unit which is connected, on the input side, to the respective sensor signal output and has, on the output side, at least one measurement detection output for outputting the signals which correspond to the at least one additional sensor. The corresponding signals may be conditioned using signal technology, for example amplified, filtered or digitized.

The first measurement detection unit may be an integrated component which is designed, in particular, to condition a multiplicity of additional detected signals from the sensors using signal technology.

The rotary encoder may alternatively or additionally have a second measurement detection unit which is connected, on the input side, to the rotary encoder signal output and has, on the output side, at least one measurement detection output for outputting the rotation signal which corresponds to the measurement variable.

The second measurement detection unit preferably converts the rotational position of the rotatable object, which is detected by the sensor, into a suitable measurement variable, for example into a rotational angle or an angular velocity. The corresponding rotation signals may be conditioned using signal technology, for example amplified, filtered or digitized.

Like the first measurement detection unit, the second measurement detection unit may be an integrated component.

In particular, the first and second measurement detection units may form an individual component. The component may be, for example, a microcontroller or microprocessor having a corresponding number of analog and/or digital inputs and outputs.

According to another advantageous embodiment, the measurement detection unit, that is to say the first and/or second measurement detection unit, has an interface module for converting signals. The interface module is connected, on the input side, to the at least one measurement detection output. On the output side, the interface module has an interface module output for outputting a corresponding interface signal.

The particular advantage of this embodiment is that the rotation signal and a multiplicity of the additional signals from the additional sensors can be output using only one interface module output.

Output is preferably effected on the basis of a time-division multiplexing method. This means that the rotation signal and the additional signals from the additional sensors are cyclically output in succession. Output is effected, in particular, in digitally coded form. Each signal may be output, for example, in a 16-bit or 32-bit format or in a floating-point data format, respective digital coding corresponding to a corresponding measured value of the associated measurement variable of the respective connected sensor.

In another embodiment, the measurement detection unit compares the respective additional signals and/or the rotation signal with predefinable comparison values. The measurement detection unit outputs a fault message if the respective comparison value is exceeded or undershot.

This reduces the amount of monitoring needed to be carried out by a monitoring unit which is connected to the rotary encoder. The measurement detection unit outputs a fault message only when a critical bearing temperature or a critical vibration value is exceeded, for example.

The measurement detection unit preferably has an interface module which converts the fault message into an interface signal which corresponds to the fault message. The interface signal can then be output at an interface module output.

This advantageously further reduces the number of components for detecting the additional sensors.

According to another embodiment, the measurement detection unit may have a data memory for storing sensor data which correspond to the additional signals detected.

This advantageously makes it possible to read even previous sensor data. Simplified fault analysis, for example in the event of the electrical machine failing, is possible on the basis of the sensor data.

The sensor data may be stored, for example, in chronological order in the sense of a history. The data memory may also be operated as a cyclic memory which is overwritten again after a predefinable memory cycle time. The memory cycle time may also be individually selected for each type of sensor.

According to another embodiment, the rotary encoder can be connected to a connecting cable having a number of signal lines. The rotary encoder preferably has, on a rotary encoder housing, a socket into which a connector of the connecting cable can be inserted.

This advantageously makes it possible to adapt the length of the connecting cable depending on the distance between the rotary encoder and a control or evaluation unit.

In an alternative embodiment, the rotary encoder has a connecting cable having a number of signal lines.

More reliable signal transmission than in the previous solution is possible on account of the lack of connecting contacts.

According to one embodiment, at least some of the signal lines are connected to the at least one rotary encoder signal output.

According to another embodiment, at least some of the signal lines can be alternatively or additionally connected to the at least one sensor signal output.

Furthermore, at least some of the signal lines may be alternatively or additionally connected to the at least one measurement detection output of the first and/or second measurement detection unit.

Furthermore, some of the signal lines may be alternatively or additionally connected to an interface module output. In this case, the number of signals lines needed in a connecting cable is considerably reduced. This is the case, in particular, when a multiplicity of the additional signals from the sensors and the rotation signals are transmitted using the time-division multiplexing method. In this case, the number of lines is limited to a few signal lines or bus lines and power supply lines for electrically supplying the electronic components in the rotary encoder and the connected sensors.

According to another embodiment, the rotary encoder preferably has a rotary encoder housing. The rotary encoder housing is typically produced from aluminum or plastic. The connection for connecting the at least one additional sensor is arranged in or on the rotary encoder housing.

As described at the outset, the connection may be, for example, a terminal strip or a socket connector which is fitted in or on the rotary encoder. The respective ends of the lines of the additional sensor can be pushed or inserted into the terminal strip or socket connector and can then be fixed.

The terminal strip or socket connector preferably terminates flush with the outside of the rotary encoder housing.

The assembly complexity for connecting the multiplicity of sensors and the wiring complexity are considerably reduced.

According to another embodiment, the rotary encoder alternatively or additionally has a sensor cable having a number of sensor lines for connecting the at least one additional sensor.

This is advantageous, for example, if the sensors to be detected are physically arranged away from the rotary encoder.

In particular, the rotary encoder is designed to connect at least one temperature sensor, vibration sensor, winding fracture sensor or switching contact as an additional sensor.

Temperature sensors are preferably used to detect the temperature of the outer bearing ring and the inner bearing ring. The temperature sensor may be a PT100 temperature sensor, for example. In order to detect the temperature of rotating parts of the electrical machine, such as the inner bearing ring or the rotor shaft, contactless temperature sensors based on pyroelectrics may be used.

Vibration sensors are used to detect vibrations produced by the electrical machine or by the drive components which are connected to the electrical machine. In particular, an imbalance of the electrical machine can be monitored with respect to an impermissible magnitude.

Switching contacts may be, for example, mechanical switches or proximity switches. If the electrical machine, for example a servomotor, has a mechanical brake, brake actuation travels or the reaching of a brake lining wear limit may be detected.

According to one particularly advantageous embodiment, the additional sensor is part of the rotary encoder and is connected to the connection of the rotary encoder.

As a result, the sensor-related spectrum of a rotary encoder as an individual component is advantageously extended beyond the detection of a rotational movement.

The sensors integrated in the rotary encoder may be, for example, vibration sensors which monitor, for example, vibrations of the electrical machine or of another system part, which vibrations have been coupled in via the rotary encoder shaft or via the rotary encoder housing.

The sensors may be, for example, temperature sensors which detect, for example, the rotor temperature which is passed on from the rotor shaft to the rotary encoder shaft.

According to another embodiment, the rotary encoder preferably has a rotary encoder housing. In this case, the at least one additional sensor is fitted to an inner side of the rotary encoder housing.

This makes it possible to detect the sensor signals in a faster manner and with greater accuracy.

In particular, a vibration sensor is rigidly fitted, as an additional sensor, to the inner side of the rotary encoder housing or of a rotary encoder housing, with the result that good transmission of structure-borne noise to the vibration sensor is enabled via the rotary encoder housing. In the case of a temperature sensor as an additional sensor, it is advantageous if a substance with good thermal conductivity, for example a thermally conductive adhesive or a thermally conductive paste, is introduced between the temperature sensor and the rotary encoder housing.

The at least one additional sensor may be, in particular, a temperature sensor or a vibration sensor.

Alternatively or additionally, a force sensor, an air pressure sensor, a hygrometric sensor, a magnetic field sensor etc. may also be accommodated in the rotary encoder housing.

The object is also achieved by an electrical machine, in particular an electric motor, which has a rotor shaft and a rotary encoder according to the invention. The at least one additional sensor is connected to the rotary encoder.

In particular, the at least one additional sensor is fitted in the electrical machine and is connected to the connection of the rotary encoder.

This considerably simplifies the manufacture and assembly of such an electrical machine. The number of components is reduced at the same time.

Further advantageous embodiments and preferred developments of the invention can be gathered from the subclaims.

The invention and advantageous embodiments thereof are described in more detail below using the following figures, in which

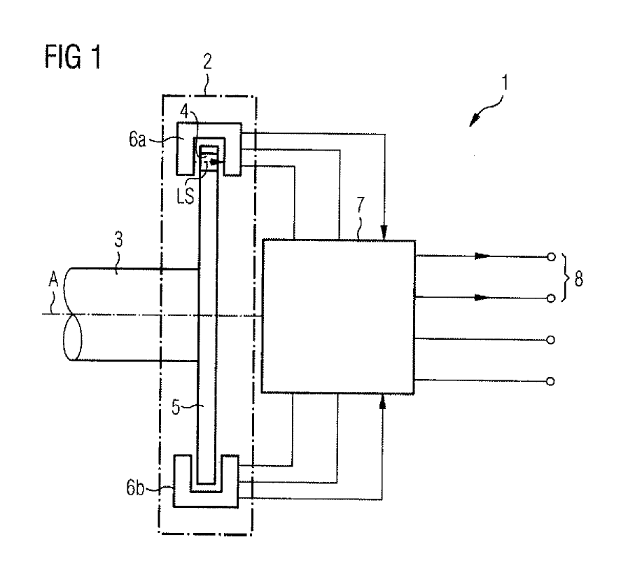

FIG. 1 shows a rotary encoder according to the prior art,

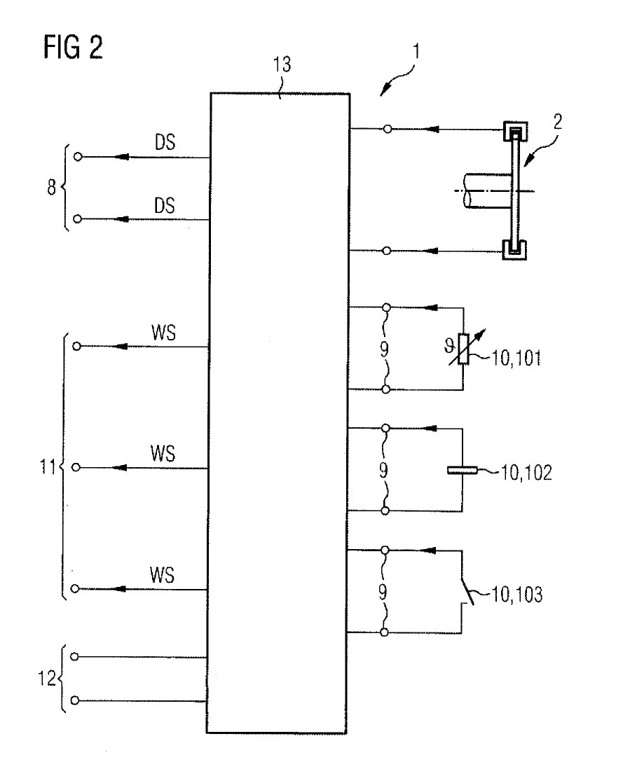

FIG. 2 schematically shows the structure of a rotary encoder according to the invention,

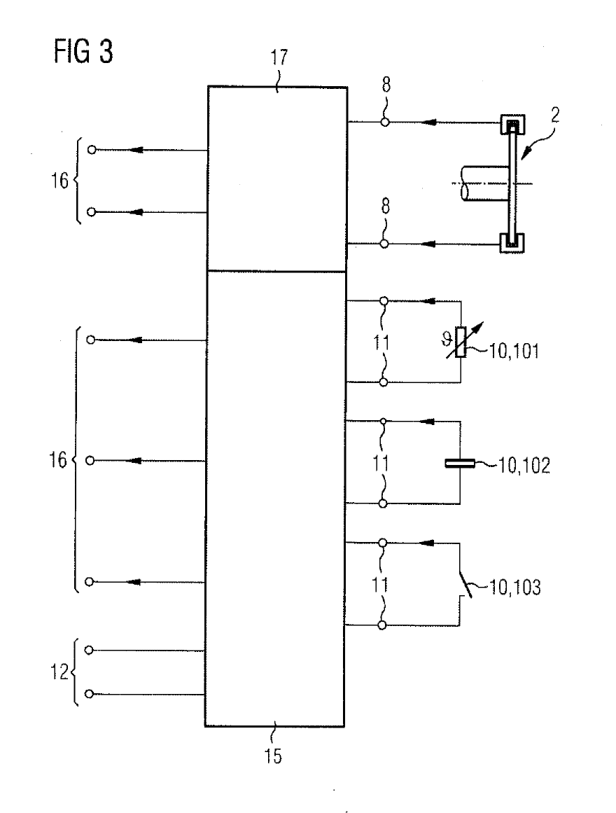

FIG. 3 shows a first embodiment of the rotary encoder according to the invention,

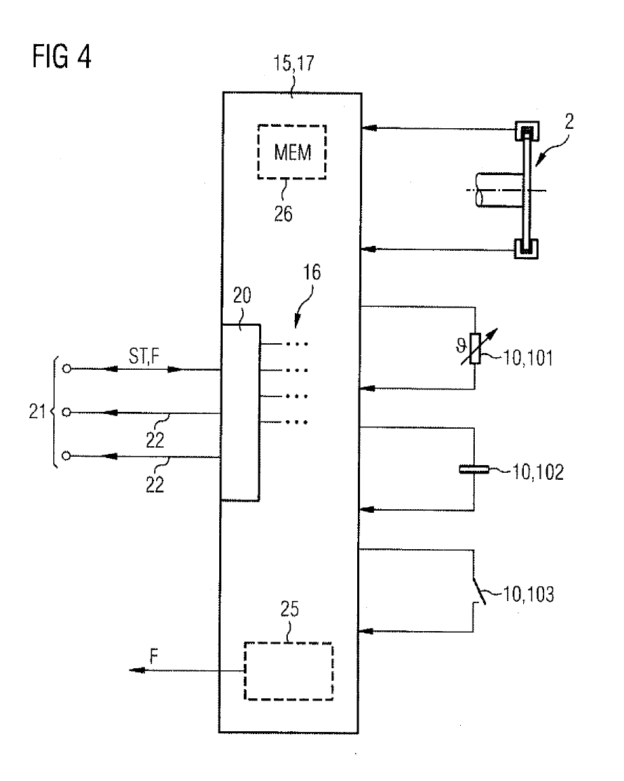

FIG. 4 shows a second embodiment of the rotary encoder according to the invention,

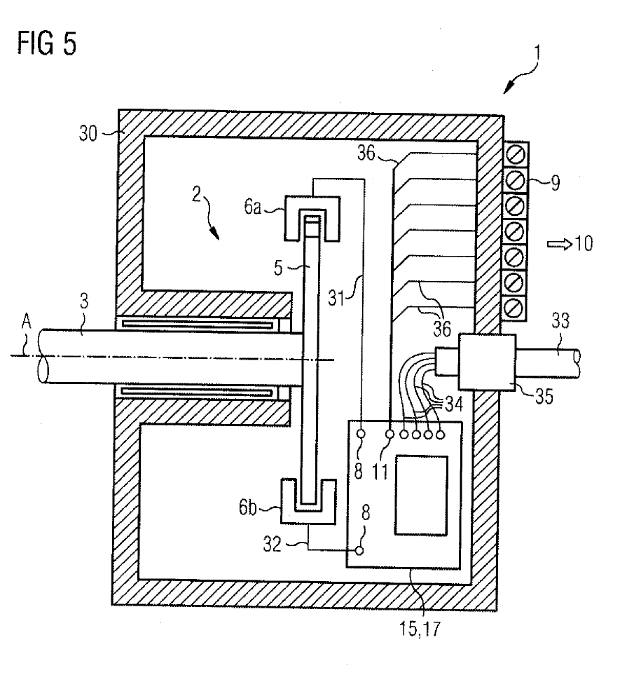

FIG. 5 shows a longitudinal section through a rotary encoder according to the invention,

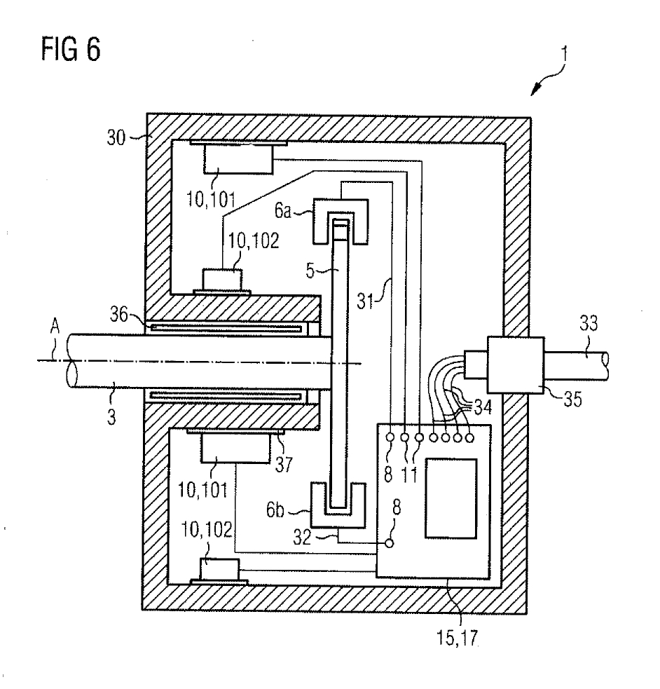

FIG. 6 shows a longitudinal section through a third embodiment of the rotary encoder according to the invention,

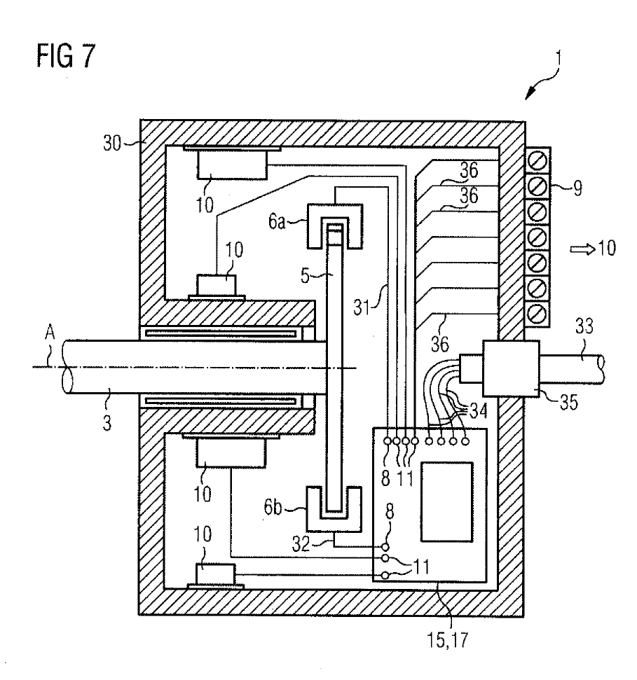

FIG. 7 shows a longitudinal section through a fourth embodiment of the rotary encoder according to the invention, and

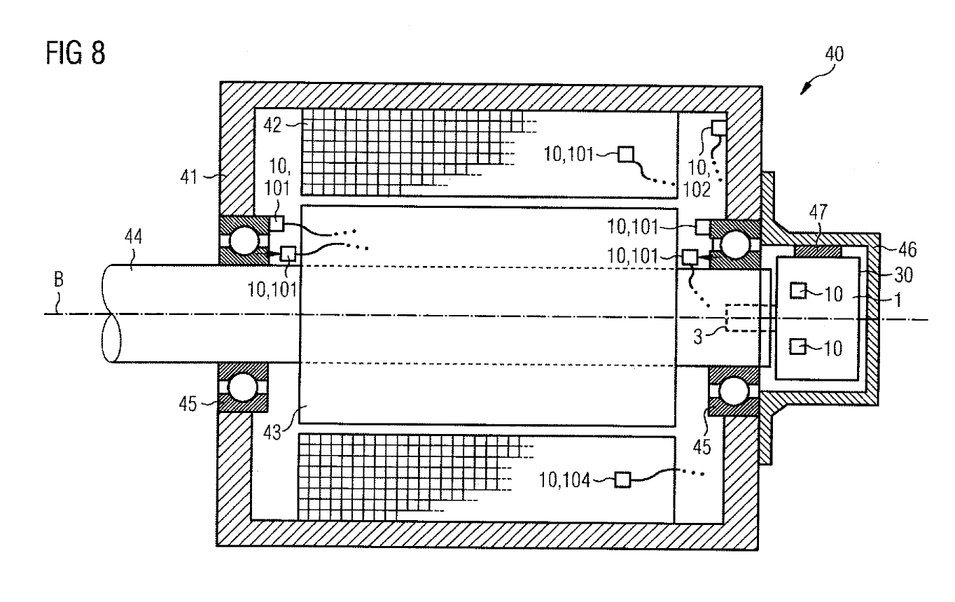

FIG. 8 shows a longitudinal section through an electrical machine having a rotary encoder according to the invention.

FIG. 1 shows a rotary encoder 1 according to the prior art. The rotary encoder 1 has a sensor 2 for detecting a measurement variable which is dependent on the rotational position of a rotatable object. The measurement variable may be, for example, an angle in degrees. The rotary encoder 1 shown has a rotary encoder shaft 3 which is connected to the rotatable object to be detected in a rotationally fixed manner. The reference symbol A is used to denote the axis of rotation of the rotary encoder 1 and the rotary encoder shaft 3. For reasons of clarity, the rotatable object is not illustrated. This object may be, for example, a motor shaft, a turntable or the like.

A scanning plate 5 which is provided with regularly arranged tangential slots 4 is fastened to that end of the rotary encoder shaft 3 which is on the rotary encoder side. “Tangential” is a direction around the axis of rotation A. Two fork-shaped photoelectric sensors 6a, 6b which are arranged such that they are offset with respect to one another and each have a light source for generating a light beam LS and a phototransistor are fitted to the edge of the scanning plate 5.

In the rotational position of the scanning plate 5 in FIG. 1, the light beam LS generated by the light source of the fork-shaped photoelectric sensor 6a can pass through the slot 4, whereas this is not the case with the fork-shaped photoelectric sensor 6b in the lower part of FIG. 1. If the scanning plate 5 rotates, the light beam LS is cyclically modulated by a slot 4 which is moving past. A rotation signal DS which is dependent on the rotational position and direction can be generated from the modulated signal from the respective phototransistor of the two fork-shaped photoelectric sensors 6a, 6b.

The rotary encoder 1 has an electronic circuit 7 for electrical supply, for metrological detection and for evaluating the modulated signals from the fork-shaped light barriers 6a, 6b. The electronic circuit 7 has a rotary encoder signal output 8 for outputting a rotation signal DS which corresponds to the measurement variable. In the example shown in FIG. 1, the rotary encoder signal output 8 has two connections.

FIG. 2 schematically shows the structure of a rotary encoder 1 according to the invention.

According to the invention, the rotary encoder 1 has a connection 9 for connecting at least one additional sensor 10. The connection 9 is illustrated in the right-hand part of FIG. 2. An additional sensor 10 may be, for example, a temperature sensor 101, for example a PT100 temperature sensor. It may be a vibration sensor 102 or a winding fracture sensor.

The additional sensors 10 are preferably fitted at locations in an electrical machine which need to be monitored, for example in the winding overhang or in the region of the motor bearings. An additional sensor 10 may be, for example, a switching contact 103, for example a reed relay contact or a proximity switch. The switching contact 103 is used, in particular, to detect switching states and actuation travels of movable components in the electrical machine. A movable component may be, for example, a brake cylinder or a plunger.

The rotary encoder 1 according to the invention also has at least one sensor signal output 11 for outputting an additional signal WS. The additional signal WS corresponds to a measurement variable detected by the at least additional sensor 10. This is shown in the left-hand part of FIG. 2. If the additional sensor 10 is a temperature sensor 101, the corresponding measurement variable may be a temperature of 80° C., for example. If the additional sensor 10 is a vibration sensor 102, the measurement variable may be a distance of 0.5 mm, for example. In the case of a switching contact 103, the measurement variable may be a binary logic value, for example “0” or “1”.

The reference symbol 13 is used to denote a signal connection unit. The latter is used distribute the power supply lines 12, the input-side signals from the sensor 2 and from the additional sensors 10 to the output-side rotary encoder signal outputs 8 and sensor signal outputs 11 using circuitry. The connection inside the signal connection unit 13 may be pure wiring without active and passive electronic components.

Alternatively or additionally, the signal connection unit 13 may have passive components, for example resistors, and/or active components such as transistors, signal drivers or comparators for amplifying or discriminating the input-side sensor signals.

FIG. 3 shows a first embodiment of the rotary encoder 1 according to the invention.

In this case, the rotary encoder 1 has a first measurement detection unit 15. The latter is connected, on the input side, to the respective sensor signal output 11 of the additional sensors 10. The first measurement detection unit 15 can thus be connected downstream of the signal distribution unit 13 described in FIG. 1. On the output side, the first measurement detection unit 15 has, for example, three measurement detection outputs 16 for outputting the sensor signals WS which correspond to the connected additional sensors 10. The signals WS may be conditioned using signal technology, for example amplified, filtered or digitized, using the first measurement detection unit 15. The first measurement detection unit 15 is preferably an integrated component, for example a microcontroller or signal processor.

The upper part of FIG. 3 illustrates a second measurement detection unit 17 which is connected, on the input side, to the rotary encoder signal output 8. On the output side, the second measurement detection unit 17 has, for example, two measurement detection outputs 16 for outputting the rotation signal DS which corresponds to the measurement variable.

According to the example shown in FIG. 3, the first and second measurement detection units 15, 17 form an individual component, for example a microcontroller or microprocessor. Such a component preferably has a corresponding number of analog and/or digital inputs and outputs for processing the sensor signals DS, WS detected.

The signal connection unit 13 shown in FIG. 2 may also be integrated in the measurement detection unit 15, 17.

FIG. 4 shows a second embodiment of the rotary encoder 1 according to the invention. The rotary encoder 1 in FIG. 4 differs from the rotary encoder illustrated in FIG. 3 by virtue of the fact that the measurement detection unit 15, 17 has an interface module 20 for converting signals. The interface module 20 is connected, on the input side, to the measurement detection outputs 16 shown in FIG. 3. On the output side, it has an interface module output 21 which can be used to output a corresponding interface signal ST. According to the example shown in FIG. 4, the interface module 20 additionally has power supply inputs 22 for electrically supplying the interface module 20 and the measurement detection unit 15, 17.

This advantageously considerably reduces the number of signal lines needed to transmit the additional signals WS and, if appropriate, the rotation signals DS. In the example shown in present FIG. 4, only one signal line is provided for the purpose of transmitting the interface signal ST.

The interface signal ST is preferably output on the basis of a time-division multiplexing method. This means that the additional signals WS and, if appropriate, the rotation signal DS are output in succession (preferably cyclically). Output may be effected, in particular, in digitally coded form.

The interface module 20 may be, for example, an RS232, USB, Firewire, CAN bus or I²C interface. The interface module 20 may be an integrated electronic component or may be part of a processor-assisted unit of the measurement detection unit 15, 17, for example a microcontroller or microprocessor.

In the example shown in FIG. 4, the measurement detection unit 15, 17 has means 25 which compare the respective additional signals WS and/or the rotation signal DS with predefinable comparison values. A fault message F is output if the respective comparison value is exceeded or undershot. The means 25 may be electronic components, for example comparators or a microcontroller.

The fault message F is available for further processing at a fault output 26 of the measurement detection unit 15, 17. Alternatively or additionally, the fault message F may also be output together with the interface signal ST via the interface module output 21.

The measurement detection unit 15, 17 shown in FIG. 4 also has an electronic data memory 26. The latter is used to store sensor data which correspond to the additional signals WS detected. The sensor data are present, in particular, in digital form. They may be obtained, for example, by subjecting the additional signals WS to analog/digital conversion in the measurement detection unit 15, 17.

If the connection 9 is alternatively in the form of a bus interface, for example a USB or Firewire interface, the additional sensor 10 already provides a digital corresponding signal WS at the sensor output. In this case, the digital sensor values may be stored in the data memory 26 as sensor data.

The data memory 26 may be operated, for example, as a cyclic memory and can be overwritten again after a predefinable memory cycle time. The memory cycle time can be individually selected for each type of sensor.

FIG. 5 shows a longitudinal section through a further rotary encoder 1 according to the invention. The sensor 2 which is known from FIG. 1 and is intended to detect a rotational position is present inside the rotary encoder 1. The reference symbol 30 is used to denote a rotary encoder housing. The latter is produced from aluminum or plastic, for example. The measurement detection unit 15, 17 can be seen in the lower right-hand part of the rotary encoder 1. The two fork-shaped photoelectric sensors 6a, 6b for detecting the rotational position are connected to said unit by means of two connection lines 31, 32.

The rotary encoder 1 also has a connecting cable 33 having a number of signal lines 34 which are connected to the measurement detection unit 15, 17. The connecting cable 33 is routed through a cable box 35 for strain relief and for sealing with respect to the rotary encoder housing 30.

Alternatively, the connecting cable 33 may be able to be connected to the rotary encoder 1. In this case, the rotary encoder 1 has a corresponding socket with a number of signal lines. The socket is preferably fitted to the rotary encoder housing 30.

In the example shown in FIG. 5, some of the signal lines 34 are connected to the rotary encoder signal outputs 8 and other signal lines are connected to the sensor signal outputs 11. The respective signal outputs 8, 11 are situated on the measurement detection unit 15, 17, in particular on a printed circuit board of the measurement detection unit 15, 17. The signal outputs 8, 11 may be in the form of a socket connector or plug connector or soldering points, for example. They are used to connect the connection lines 31, 32 to the sensor 2 and to connect the connection lines 36 to the additional sensors 10 which can be connected via the connection 9.

Some of the sensor lines 36 may also be connected to the measurement detection outputs 16 and/or to the interface output 21 of the interface module 20 of the measurement detection unit 15, 17.

In the example shown in FIG. 5, the connection 9 for connecting additional sensors 10 is arranged on the rotary encoder housing 30. The connection 9 is a terminal strip, for example, and is fitted to the outside of the rotary encoder housing 30.

The terminal strip 9 may alternatively also be accommodated in a recess in the rotary encoder housing 30. The terminal strip 9 preferably terminates approximately flush with the outside of the rotary encoder housing 30. The connection 9 may alternatively also be a socket connector or plug connector.

Seven ends of the lines of the additional sensors 10 may be inserted into the terminal strip 9 shown in FIG. 5 and may be screwed to the terminal strip 9. The terminal strip 9 may also be designed, for example, to accommodate 2, 4, 8, 10 or 17 additional sensors 10, for example.

Two or three terminals are preferably provided for each additional sensor 10. One or two terminals may be provided for supplying power to the additional sensors 10.

The connection 9 may also be in the form of at least one bus interface, for example a USB, Firewire, CAN or I²C bus interface. In the case of a USB or Firewire interface, power can be supplied to an additional sensor 10, which can be connected, via the corresponding USB or Firewire connecting socket 9. Miniature designs of the connecting sockets 9 are available, with the result that a multiplicity of connecting sockets 9 can be fitted to the outside of the rotary encoder 1. For connection purposes, the additional sensors 10 have a suitable connector at the respective end of their lines.

The rotary encoder 1 may alternatively or additionally have a sensor cable having a number of sensor lines for the purpose of connecting additional sensors 10. The sensor cable may be routed through the rotary encoder housing 30 in a corresponding manner, as shown in FIG. 5 using the example of the connecting cable 33, and may be connected there to the measurement detection unit 15, 17, for example. The sensor cable may alternatively be inserted into a corresponding sensor socket on the outside of the rotary encoder 1. The sensor cable may also have a terminal strip, plug connector or socket connector, for example, at its free end. Alternatively, the respective sensor lines of the sensor cable may also be directly “wired” to the additional sensors 10 in the sense of a cable harness.

FIG. 6 shows a longitudinal section through a second embodiment of the rotary encoder 1 according to the invention. The rotary encoder shown in FIG. 6 differs from that in FIG. 5 by virtue of the fact that the additional sensors 10 are fitted inside the rotary encoder 1. The additional sensor 10 is thus part of the rotary encoder 1. The rotary encoder 1 still forms a structural unit. The additional sensors 10 shown are connected to the rotary encoder 1. In the example shown in FIG. 6, the additional sensors 10 are connected to the measurement detection unit 15, 17 by means of connection lines which are not described any further.

The additional sensors 10 are preferably temperature sensors 101 or vibration sensors 102 for detecting ambient heat or vibration acting on the rotary encoder 1 from the outside. The ambient heat may be, for example, the temperature of a stator or a machine housing of an electrical machine. The vibration may originate, for example, from an imbalance inside the electrical machine. The additional sensor 10 inside the rotary encoder 1 may also be an air pressure sensor or a hygrometric sensor, for example. In principle, the additional sensor 10 accommodated in the rotary encoder 1 may be of any desired type of sensor if the respective measurement variable to be detected can be detected via the rotary encoder housing 30 or via the rotary encoder shaft 3.

The additional sensors 10 are preferably fitted to an inner side of the rotary encoder housing 30. This is shown in FIG. 6. A temperature sensor 101 for detecting the heat acting via the outside of the rotary encoder housing 30 is illustrated in the upper part of the rotary encoder 1.

A vibration sensor 102 which is rigidly connected to the inner side of the rotary encoder housing 30 is shown in the region of a bearing 36 for guiding the rotary encoder shaft 3. As a result, a vibration, for example from a rotor of an electrical machine, which is coupled in via the rotary encoder shaft 3 can be detected in a particularly effective manner.

A further temperature sensor 101 is also shown in the region of the bearing 36. Said sensor is connected to the inner side of the rotary encoder housing 30 via a thermally conductive connection 37. Heat which acts via the rotary encoder shaft 3 can thus be detected in a particularly effective manner. The heat which acts may originate, for example, from a rotor shaft of an electrical machine which is connected to the rotary encoder shaft 3 in a rotationally fixed manner and, to a certain extent, in a thermally conductive manner.

A further vibration sensor 102 is illustrated in the lower part of FIG. 6. Said vibration sensor can be used, in particular, to detect vibrations via the outside of the rotary encoder housing 30.

FIG. 7 shows a longitudinal section through a third embodiment of the rotary encoder 1 according to the invention. This embodiment is a combination of the first and second embodiments of the rotary encoder 1 shown in FIG. 5 and FIG. 6.

In this case, the rotary encoder 1 already has additional sensors 10 in its interior. Additional sensors and additional sensors 10 which are external to the respective field of use of the rotary encoder 1 may be optionally connected via the connection 9. The rotary encoder 1 shown in FIG. 7 can therefore be used in a particularly flexible manner.

FIG. 8 shows a longitudinal section through an electrical machine 40 having a rotary encoder 1 according to the invention.

The electrical machine 40 shown is an electric motor. It has a machine or motor housing 41 in which a stator 42 and a rotor 43 are accommodated. The rotor 43 has a rotor shaft 44 which is guided in two motor bearings 45. The reference symbol B is used to denote an axis of rotation of the electrical machine 40.

The electrical machine 40 also has a rotary encoder 1 according to the invention, the rotary encoder shaft 3 of which is connected to the rotor shaft 44 in a rotationally fixed manner. In the example shown in FIG. 8, the rotary encoder shaft 3 is fastened to an axial end of the rotor shaft 44 in a corresponding hole. If, in contrast, the rotary encoder shaft 3 is in the form of a hollow shaft, it may surround an axial end of the rotor shaft 44 or an axial rotor shaft stub in a rotationally fixed manner. In both cases, the axis of rotation A of the rotary encoder 1 and the axis of rotation B of the electrical machine 40 correspond. The rotary encoder shaft 3 may alternatively also be connected to the rotor shaft 44 by means of a V-belt or toothed belt. In this case, a V-belt or toothed belt pulley is fitted to the end of the rotary encoder shaft 3.

Furthermore, the rotary encoder housing 30 of the rotary encoder 1 is connected to a protective cap 46 of the electrical machine 40 by means of a connecting element 47. The connecting element 47 is used as a torque support for the rotary encoder 1.

The rotary encoder housing 30 may alternatively be part of the machine housing 41. The rotary encoder housing 30 may also alternatively be part of the protective cap 46 or part of an end frame of the electrical machine 40.

According to the invention, at least one additional sensor 10 is connected to the rotary encoder 1. In the example shown in FIG. 8, seven additional sensors 10 are fitted for the purpose of monitoring and/or controlling the electrical machine 40. The respective sensor signal lines are only depicted rudimentarily for reasons of a better overall view. They are usually laid inside the electrical machine in shielded form in the sense of a cable harness.

In the example shown in FIG. 8, a temperature sensor 101 is installed in the upper part of the stator 42 of the electrical machine 40, in particular in the thermally critical winding overhang. A winding fracture sensor 104, for example, is installed in the lower part of the stator 42. A vibration sensor 102 which is fitted to an inner side of the machine housing 41 is shown in the upper right-hand part of FIG. 8. Furthermore, temperature sensors 101 for monitoring the two motor bearings 45 are shown. The temperature sensors 101 which are radially further to the outside relative to the axis of rotation B of the electrical machine detect a respective outer bearing temperature. The two temperature sensors 101 which are radially further inside detect a respective inner bearing temperature. Detection is effected in a contactless manner, on account of the inner bearing ring which rotates during operation of the electrical machine 40, for example by means of an infrared temperature sensor based on pyroelectrics.

According to the invention, the rotary encoder 1 has additional sensors 10 which are part of the rotary encoder 1. In the example shown in FIG. 8, the rotary encoder 1 has two additional sensors 10. These sensors can be used to detect, for example, vibrations or temperatures from the rotor shaft 44 of the electrical machine 40 or from the machine housing 41 via the protective cap 46 and also via the connecting element 47. In this case, the connecting element 47 has a comparatively low thermal resistance and, at the same time, a high level of rigidity.

1.-21. (canceled)

22. A rotary encoder, comprising:
a housing;
a sensor to detect a measurement variable which is dependent on a rotational position of a rotatable object;
at least one rotary encoder signal output to output a rotation signal which corresponds to the measurement variable;
a connection provided in or on the housing for connecting at least one additional sensor outside the rotary encoder; and
at least one sensor signal output to output an additional signal which corresponds to a measurement variable detected by the at least one additional sensor.

23. The rotary encoder of claim 22, wherein the connection is configured in the form of at least one bus interface which is arranged on the rotary encoder housing.

24. The rotary encoder of claim 23, wherein the at least one bus interface comprises a bus interface socket.

25. The rotary encoder of claim 23, wherein the at least one bus interface comprises a USB, Firewire or CAN or I²C bus interface.

26. The rotary encoder of claim 22, further comprising a measurement detection unit having an input side connected to the at least one sensor signal output, and an output side having at least one measurement detection output to output the additional signal which corresponds to the at least one additional sensor.

27. The rotary encoder of claim 22, further comprising a measurement detection unit having an input side connected to the rotary encoder signal output, and an output side having at least one measurement detection output to output the rotation signal which corresponds to the measurement variable.

28. The rotary encoder of claim 26, wherein the measurement detection unit has an interface module for converting signals, said interface module having an input side connected to the at least one measurement detection output and an output side having an interface module output outputting a corresponding interface signal.

29. The rotary encoder of claim 27, wherein the measurement detection unit has an interface module for converting signals, said interface module having an input side connected to the at least one measurement detection output and an output side having an interface module output outputting a corresponding interface signal.

30. The rotary encoder of claim 26, wherein the measurement detection unit is constructed to compare the additional signal with a predefinable comparison value and outputs an error message in the event the comparison value is exceeded or the additional signal falls short of the comparison value.

31. The rotary encoder of claim 27, wherein the measurement detection unit is constructed to compare the rotation signal with a predefinable comparison value and outputs an error message in the event the comparison value is exceeded or the rotation signal falls short of the comparison value.

32. The rotary encoder of claim 30, wherein the measurement detection unit has an interface module which converts the error message into an interface signal which corresponds to the error message and is outputs the error message at an interface module output.

33. The rotary encoder of claim 31, wherein the measurement detection unit has an interface module which converts the error message into an interface signal which corresponds to the error message and outputs the error message at an interface module output.

34. The rotary encoder of claim 26, wherein the measurement detection unit has a data memory storing sensor data which correspond to the additional signal.

35. The rotary encoder of claim 27, wherein the measurement detection unit has a data memory storing sensor data which correspond to the rotation signal.

36. The rotary encoder of claim 26, wherein the measurement detection unit is a microcontroller or microprocessor.

37. The rotary encoder of claim 27, wherein the measurement detection unit is a microcontroller or microprocessor.

38. The rotary encoder of claim 22, wherein the rotary encoder is connected to a connection cable having a plurality of signal lines.

39. The rotary encoder of claim 22, further comprising a connection cable having a plurality of signal lines.

40. The rotary encoder of claim 39, wherein at least some of the signal lines are connected to the at least one rotary encoder signal output.

41. The rotary encoder of claim 39, wherein at least some of the signal lines are connected to the at least one sensor signal output.

42. The rotary encoder of claim 22, constructed for attachment of at least one additional sensor selected from the group consisting of temperature sensor, vibration sensor, winding fracture sensor and switching contact.

43. An electrical machine, comprising:
a rotor shaft; and
a rotary encoder including a housing, a sensor to detect a measurement variable which is dependent on a rotational position of the rotor shaft, at least one rotary encoder signal output to output a rotation signal which corresponds to the measurement variable, a connection provided in or on the housing for connecting at least one additional sensor outside the rotary encoder, and at least one sensor signal output to output an additional signal which corresponds to a measurement variable detected by the at least one additional sensor.

44. The electric machine of claim 43, wherein the electric machine is an electric motor.
